(19) United States
(12) Patent Application Publication
(10) Pub. No.: US 2026/0219037 A1
(43) Pub. Date: Jul. 30, 2026

(54) POLARIZATION INTERFEROMETER

(71) Applicant: Onto Innovation Inc., Wilmington, MA (US)

(72) Inventors: Bradley Kimbrough, Tucson, AZ (US); James Millerd, Aptos, CA (US); Erik Novak, Tucson, AZ (US); Neal Brock, Tucson, AZ (US)

(73) Assignee: Onto Innovation Inc., Wilmington, MA (US)

(21) Appl. No.: 19/143,197

(22) PCT Filed: Dec. 28, 2023
(86) PCT No.: PCT/US2023/086320

§ 371 Date: Jun. 25, 2025

Related U.S. Application Data
(60) Provisional application No. 63/435,868, filed on Dec. 29, 2022.

(51) Int. Cl. G01B 11/30

(52) U.S. Cl. CPC G01B 11/30

(57) ABSTRACT

A polarization interferometer is configured to characterize a test object quickly and precisely, and in particular, the surface roughness of the test object. The polarization interferometer includes an illumination source that produces light having multiple wavelengths. The light is split into two orthogonally polarized beams including a reference beam and a test beam, which is incident on and returned from the test object. The reference beam and test beam are combined into a combined beam. At least one spectral filter separates the combined beam into two spectral channels having different center wavelengths. Two pixelated polarization phase sensors captures images of the two spectral channels at the same time and produce a phase map that can be used to measure characteristics of the test object.

### CROSS REFERENCE TO RELATED APPLICATIONS

This application claims priority under 35 U.S.C. § 119 to U.S. Provisional Application No. 63/435,868, filed Dec. 29, 2022, entitled “SURFACE ROUGHNESS INTERFEROMETER,” which is assigned to the assignee hereof and is incorporated herein by reference in its entirety.

### FIELD OF THE DISCLOSURE

Subject matter described herein is related to interferometry and more particularly to polarization interferometry using pixelated polarization phase sensors that capture multiple spectral channels.

### BACKGROUND

Polarization, or phase-shift, interferometry is an established optical method for precision measurement of a variety of physical parameters including the surface shape and roughness of optically smooth objects. Optically smooth objects have a local roughness RMS (root mean square) that is under 1/30 of the measurement wavelength used for testing, and a height variation, within the optical resolution area and between sampling points, that is less than ¼ of the measurement wavelength, and which wavelength may range from nanometers to microns. In phase shifting interferometry, multiple data frames of irradiance, e.g., images, of the object are acquired. Each frame is acquired at a different relative phase-shift between the interfering reference and test beams and the data is processed by computer to determine the relative path-difference between the reference and object surface with high accuracy. Unambiguous interferometric measurements require that the object surface does not have any local steps or discontinuities greater than the ¼ of the measurement wavelength used for object testing. The apparent optical smoothness depends not only on surface characteristic, but also on system parameters such as the wavelength of light used for testing and the optical resolution of the imaging and illumination. Surfaces of greater roughness need to be measured with other methods that extend the vertical range of the measurement such as fringe projection, coherence scanning, or multiple wavelength interferometry. Methods that extend the vertical range of the measurement often do not have good vertical resolution or are not instantaneous. A solution that provides both precise and instantaneous assessment of surface roughness is desirable.

### SUMMARY

A polarization interferometer uses multiple spectral channels that are captured at the same time for characterizing a test object, such as surface roughness of the test object. The polarization interferometer may include an illumination source that produces light having multiple wavelengths. The polarization interferometer further includes polarization interferometer optics that split the light into two orthogonally polarized beams, including a reference beam and a test beam, wherein the test beam is incident on and is returned from the test object. The polarization interferometer optics recombine the test beam and the reference beam into a combined beam. At least one spectral filter spectrally filters the combined beam into two spectral channels. A first spectral channel has a first center wavelength and a second spectral channel has a second center wavelength that is different than the first center wavelength. The polarization interferometer further includes two pixelated polarization phase sensors that are configured to capture images of the two spectral channels at the same time in the two pixelated polarization phase sensors. The two pixelated polarization phase sensors are further configured to produce a phase map corresponding to an equivalent wavelength for the first center wavelength and the second center wavelength. A computer is used to determine the surface roughness based on the phase map, where the surface roughness height variations are greater than 20 nanometers (nm) root mean square (RMS).

A method of polarization interferometry for characterizing a test object includes producing light having multiple wavelengths with an illumination source. The method further includes splitting the light into two orthogonally polarized beams including a reference beam and a test beam with polarization interferometer optics. The test beam is incident on and is returned from the test object, and recombining the test beam and the reference beam into a combined beam with the polarization interferometer optics. The method includes spectrally filtering the combined beam into two spectral channels with at least one spectral filter. A first spectral channel has a first center wavelength and a second spectral channel has a second center wavelength, wherein the first center wavelength and the second center wavelength are different. The method further includes capturing images of the two spectral channels at a same time with two pixelated polarization phase sensors, and producing a phase map for a surface of the test object corresponding to an equivalent wavelength for the first center wavelength and the second center wavelength. The method also includes determining the surface roughness based on the phase map, where the surface roughness height variations are greater than 20 nanometers (nm) root mean square (RMS).

Other objects, features and advantages of the present disclosure will become apparent to those skilled in the art from a consideration of the following detailed description taken in conjunction with the accompanying drawings and claims.

### BRIEF DESCRIPTION OF THE DRAWINGS

FIG. 1 is a schematic perspective view of a polarization interferometer, particularly illustrating the measurement apparatus with functional blocks.

FIG. 2 illustrates the spectral characteristics of the light source and the relative transmittance of the optical filters.

FIG. 3 is a plan view of the pixelated polarizer array illustrating one implementation of the phase-sensor that may be used in the polarization interferometer.

FIG. 4 is a schematic view of a polarization interferometer configured using Mireau-type interferometer optics.

FIG. 5 is a schematic view of a polarization interferometer configured using Linnik-type interferometer optics.

FIG. 6 is a schematic view of one implementation of a splitter and spectral filter and dual phase sensors that may be used in the polarization interferometer.

FIGS. 7A-7F illustrate various configurations of the dual spectral channels and dual-phase sensors that may be used with the polarization interferometer.

FIG. 8A and FIG. 8B illustrate sub-pixel alignment of corresponding pixels in the pixelated polarization phase sensors used in the polarization interferometer.

FIG. 9 a pixelated polarization phase sensor with an RGB (red, green, blue) Bayer filter.

FIG. 10 shows an example of data obtained using a measurement system configured according to the present disclosure.

### DETAILED DESCRIPTION

Phase-shift interferometry may be used for precision measurement of a variety of physical parameters. Unambiguous interferometric measurements require that the surface under test does not have any local steps or discontinuities greater than ¼ of the wavelength used for the interferometry measurement. This severely limits the range of surfaces that can be measured. While there are techniques to extend the measurement range, for example, fringe projection, coherence scanning, or multiple wavelength interferometry, these techniques are traditionally problematic due to an increase in measurement capture time, loss of precision due to vibrations, and inaccuracies due to chromatic dispersion.

To extend the measurement range, phase-shifting measurements can be made at two or more wavelengths and the results combined to produce a measurement with a reduced sensitivity of a longer “equivalent” wavelength, λeq, which can be controlled through the selection of the two wavelengths chosen for measurements according to the equation:

$$λ e q = \frac{λ 1 λ 2}{\vert λ1 - λ2 \vert} \qquad ( 1 )$$

where, λ1 and λ2 are the two measurement wavelengths. Equivalent wavelengths of microns to millimeters can be generated through the proper choice of the measurement wavelength. While measuring at two or more wavelengths extends the vertical range of surfaces and surface roughness that can be measured, additional time is typically required to acquire the extra wavelength data in addition to the phase-shifting data resulting in high sensitivity to motion and vibration during acquisition. Precision measurements require vibration isolation and/or very tight coupling between the test article and the interferometer.

Pixelated polarizer arrays may be fabricated where each pixel element has a different polarizer orientation in a repeating pattern. These micro-polarizer arrays can be combined with a polarization interferometer to accomplish single frame phase-shifting measurements at a single wavelength. The two-wavelength technique may be combined with the pixelated polarizer sensors, a microscope polarization interferometer, and switchable two wavelength illumination, to accomplish surface roughness measurements of surfaces with depth of local roughness in excess of the ¼ of individual wavelengths. This method uses at least two frames of data, where the light sources were switched between exposures. Thus, this implementation does not afford the significant vibration immunity that is characteristic of true single frame measurements. Additionally, it was found that chromatic dispersion required changes to the instrument focus between measurements, further increasing the measurement time.

Pixelated color filters may be interlaced with the pixelated polarizers array to accomplish single frame, multi-wavelength measurements. Typically, these are RGB (red, green and blue) color filters. However, the pixels at each wavelength are necessarily displaced from one another due to the interlaced nature of the array. The lateral displacement between differing color pixels makes it impossible to measure surfaces with high spatial-frequency random phase, such as an optically rough surface, because the different color images will not come from the same location on the test surface. Additionally, the monolithic interlaced sensor does not allow for independent adjustment to compensate for chromatic dispersion at each wavelength further reducing the practical use for surface roughness measurements. Therefore, this method is generally limited to measuring optically smooth surfaces.

As discussed herein, a polarization interferometer may include a combination of dual spectral channels and dual-phase sensors, where both phase sensors capture images of the spectral channels simultaneously. The simultaneous capture of dual spectral channels in the polarization interferometer may be used to produce optical measurements, e.g., surface roughness, in a single snap-shot, thus enabling a vibration immune measurement system that works over a wide range of surface roughness or discontinuity values. As used herein, simultaneously capturing the spectral channels by the phase sensors indicates that the phase sensors are exposed to the respective images of the spectral channels coincidentally during at least 90% of the exposure time or so that neither phase sensor sees a change in the optical path difference of more than a few nanometers with respect to the other phase sensor.

Measurement of surface features even when (or up to) the height variations are of high spatial frequency, e.g., local height variations are larger than λ/8 or λ/4 over a single pixel width, where λ is the equivalent wavelength of the measurement light. It should be understood that the polarization interferometer, as discussed herein, may be used for measurement of, e.g., steps, gratings, or other features, or surfaces that are relatively smooth, e.g., have slowly varying features (vary with low spatial frequency), or surfaces that are relatively rough, e.g., have quickly varying features (vary with high spatial frequency). Smooth surfaces, such as glass, can have surfaces that have neighboring height variations of less than 20 nanometers (nm) root mean square (RMS). The polarization interferometer can measure smooth surfaces as well as surfaces of objects that have greater than 20 nm RMS up to several micrometers or microns. In one implementation, the polarization interferometer can measure quickly and precisely from several nanometers RMS (e.g., 4 nm RMS) to 10 micrometers RMS. The measurements of surface roughness can be 50 nm RMS, 100 nm RMS, 250 nm RMS, 400 nm RMS, or any number between 4 nm RMS to 10 micrometers RMS. Moreover, the interferometer with the dual spectral channel, dual-phase sensors may be configured to respond better to chromatic dispersion existing in the optical path. Many industries utilize surface roughness measurements in research and development, quality control and manufacturing, including the semiconductor and medical industries, thus the present disclosure is relevant to a wide variety of applications.

In some implementations, the dual spectral channels may be produced with a non-polarizing beam splitter and spectral filters in each beam path to produce spectral channels having different center wavelengths. In some implementations, the dual spectral channels may be produced with a dichroic beam splitter that splits and spectrally filters light from polarization interferometer optics to produce the channels having the different center wavelengths. In some implementations, the dual spectral channels may be produced at the camera level, e.g., the sensor(s) having spectral filtration incorporated directly on or associated with the sensor(s). The dual phase sensors may be dual pixelated polarization phase sensors that receive the light in the first and second channels. The dual phase sensors are configured to receive the two channels in focus and may be laterally aligned to receive the same image with sub-pixel accuracy. The phase sensors may be in physically separated, e.g., different phase arrays in different cameras, or may be different phase arrays in a single camera, e.g., mounted on a single monolithic block, or may be different regions of the same sensor phase array in a single camera. The dual phase sensors may produce a phase map corresponding to an equivalent wavelength for the first center wavelength and the second center wavelength in a single shot, which may be used to characterize the test object, such as surface roughness.

The polarization interferometer provides a useful arrangement for performing quantitative, instantaneous measurement of surface roughness, particularly for optically rough surfaces where the neighboring height discontinuities are greater than ¼ of the measurement wavelength. In some implementations, a measurement device may include a combination of a broadband light source that is filtered for polarization; a microscope-based polarization interferometer that divides the illumination into two orthogonally polarized beams, one containing the phase of the object under test, the other from a high-quality reference surface; a mechanism to further split the combined reference and test beams into two separate channels; a means for spectrally filtering each channel independently at a different center wavelength; two pixelated detector regions with a polarizers array subdivided into a plurality of sets of pixels with polarizers, such that each set produces a predetermined phase shift between orthogonally polarized test and reference beams; and a means to focus and align the images onto the two detector regions to within sub-pixel accuracy. Thus, each detector region simultaneously produces a pixelated phase-shifted interferograms at a different center wavelength.

In accordance with some implementations, it is possible in a single snap-shot to measure the surface roughness of objects having local height discontinuities greater than one-quarter of the optical wavelength and less than the ¼ equivalent wavelength generated by capturing and processing measurements at two or more wavelengths. The present disclosure provides an improvement over conventional methods employing two or more wavelengths because all required wavelength and phase shift information are captured simultaneously, significantly extending the tolerance to vibration and motion. It also provides improvement over methods using pixelated RGB color filter array in combination with a pixelated polarizer array detector, which has the disadvantage of a large pixel separation between spectral channels, which limits the practical measurement of rough surfaces. Pixelated polarizer array detector, or pixelated waveplate array, is also called a phase sensor as it allows for instantaneous phase measurement between impinging orthogonally polarized beams. Such detector can be purchased with already embedded polarizers or waveplates in sensor pixels or their array, called often pixelated phase mask, can be placed over the regular sensor array.

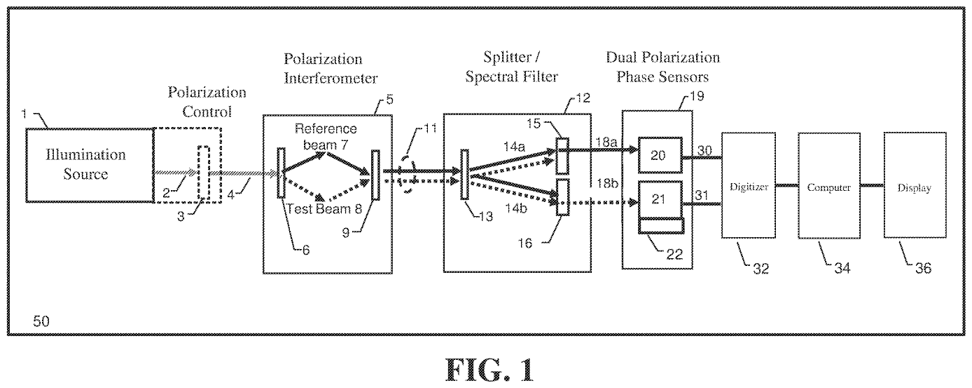

Turning to the drawings, wherein like parts are designated throughout with like numerals and symbols, FIG. 1 illustrates schematically a complete measurement system 50 that depicts the functionality according to the present disclosure. The measurement system 50 is a polarization interferometer and accordingly is sometimes referred to as a polarization interferometer 50. It should be understood that some of the functionality that is illustrated in FIG. 1 with two or more separate components may be implemented by a single or fewer elements. Conversely, it should be understood that some of the functionality that is illustrated in FIG. 1 with a single component may be implemented by multiple elements. Various specific implementations of the measurement system are further described below.

The polarization interferometer 50, for example, enables single shot measurements with high spatial resolution, e.g., sub-micron lateral resolution, and a large field of view, e.g., few hundred microns to greater than 1 mm field of view. The system includes an illumination source 1 that produces light 2 that has at least two wavelengths. The illumination source 1, for example, may be broadband illumination source, such as a frequency comb laser, laser diode, LED or other light source that produces light with multiple wavelengths that are separated, e.g., by 10 nm or more. In some implementations, the illumination source 1 may include two separate light sources, such as two lasers, laser diodes, LEDs, or other light sources, or any combination thereof, that produce light with separate wavelengths that is combined into a single beam, illustrated by light 2. By way of example, multiple light sources may be coupled with optical fibers to practical operate as a single light source with different wavelengths. The illumination source 1 may produce light with a center wavelength λ0. The illumination source 1 may further produce light that is polarized and is at least partially spatially and temporally coherent. In some implementations, the illumination source 1 may include a polarizer that polarizes light. In some implementations, the illumination source 1 may include a light source that produces polarized light, such as when the illumination source 1 is a laser. In some implementations, at least one polarization control element 3, such as a polarizer, may be used to independently control the polarization of the polarized beam 4. In some implementations, the polarization control element 3 may be considered part of the illumination source 1 or may not be present. The selection of illumination source 1 may be based on a combination of power and spectral bandwidth or wavelength bands.

The polarized beam 4 enters microscope-based polarization interferometer optics 5, which may have a numerical aperture of 0.3 or higher, and that split the light into orthogonal polarized beams. As illustrated polarization interferometer optics 5 include an element 6 that split the polarized beam 4 into a reference beam 7 having a predetermined polarization, and a test beam 8 having an orthogonal polarization to reference beam 7, and a beam combiner 9 that recombines the test beam 8 with reference beam 7 to be substantially colinear. The test beam 8 is incident on and returned by a test object (not shown). FIG. 1 functionally illustrates the element 6 as splitting the polarized beam 4, but it should be understood that element 6 may additionally generate the orthogonal polarization states, e.g., if the element 6 is a polarizing beam splitter. Moreover, while element 6 and beam combiner 9 are functionally illustrated as separate components in FIG. 1, it should be understood that the functionality may be implemented with a single component.

The combined beam 11 is split into two spectral channels having differing center wavelengths. For example, FIG. 1 illustrates the combine beam 11 directed to a splitter and spectral filter section 12 where a non-polarizing beam-splitter 13 divides the combined beam 11 into two sub-beams 14a and 14b. Sub beam 14a is filtered by first spectral filter 15 having a center wavelength of λ1, to create a first spectral channel 18a which is imaged onto a first phase-sensor 20. Sub-beam 14b is filtered by second spectral filter 16 having a center wavelength of λ2, to create a second channel 18b that is imaged on second phase-sensor 21. The spectral channels, however, may be produced in different manners. For example, in some implementations, the spectral channels 18a and 18b may be produced using a dichroic beam-splitter 13 that splits the combined beam 11 into the separate channels 18a and 18b, thereby obviating the need for spectral filters 15 and 16. In some implementations, the functionality of the splitter and spectral filter section 12 may be implemented at least partially in the dual phase-sensor section 19. For example, polarization pixelated cameras may include spectral filters, and thus, the filtering into the two spectral channels may be performed at the camera level. In another implementation, the separate spectral channels 18a and 18b may be generated with a metasurface that is configured to spectrally separate each point (or pixel) of the image of the test object into spectral channels 18a and 18b that are received at corresponding pixels of a phase sensor. The first phase sensor 20 and second phase sensor 21 in the dual phase-sensor section 19 can be aligned with respect to each other, and allow focusing to compensate for any chromatic difference. Alignment of the phase sensors 20 and 21 may be performed mechanically using positioning stage 22. In some implementations, the phase sensors 20 and 21 may be further aligned digitally.

First phase sensor 20 and second phase sensor 21 may include a polarization or waveplate array that introduces an effective phase-delay between the filtered reference and test beams within each spectral channel 18a and 18b, respectively, at each pixel and subsequently interferes the transmitted light; and a detector array that converts the optical irradiance sensed at each pixel to an electrical signal, 30 and 31 respectively. The polarization interferometer 50 may also include a digitization circuit 32 (digitizer) that converts the voltage to a digital bit stream, a computer 34 that processes the digital bit stream to control operations of the polarization interferometer 50, calculate optical phase difference and, and store and/or report, e.g., via a display 36, the result and may permit user interaction in conventional manner.

The wavelengths λ1 and λ2 produced in the channels 18a and 18b are used to produce the desired equivalent wavelength, λeq, from equation 1. As can be seen in equation 1, the equivalent wavelength is inversely proportional to the difference in wavelengths λ1 and λ2, and as the two wavelengths get close to each other, the resulting equivalent wavelength will increase. However, the noise also scales with equivalent wavelength, e.g., on the order of λ/50. Accordingly, the selection of the illumination source 1 and the spectral filters (e.g., filters 15 and 16) that produce the spectral channels may be made to tune the equivalent wavelength to be larger than the discontinuities of the surface being measured in order to avoid the phase ambiguities (2π errors), but as small as possible to optimize the signal to noise ratio. For example, an equivalent wavelength of approximately 4× the maximum surface height may be a good compromise to avoid phase ambiguities while still keeping the equivalent wavelength as low as possible to minimize noise. In some implementations, the two-wavelength measurement may be combined with single wavelength data to obtain improved vertical resolution when the noise is less than the ¼ A of the wavelength (again, to avoid phase ambiguities). Accordingly, in some implementations, the illumination source 1 (and the one or more spectral filters) may be selected to produce an equivalent wavelength of approximately 12× the fundamental or around 7 microns for rough surfaces.

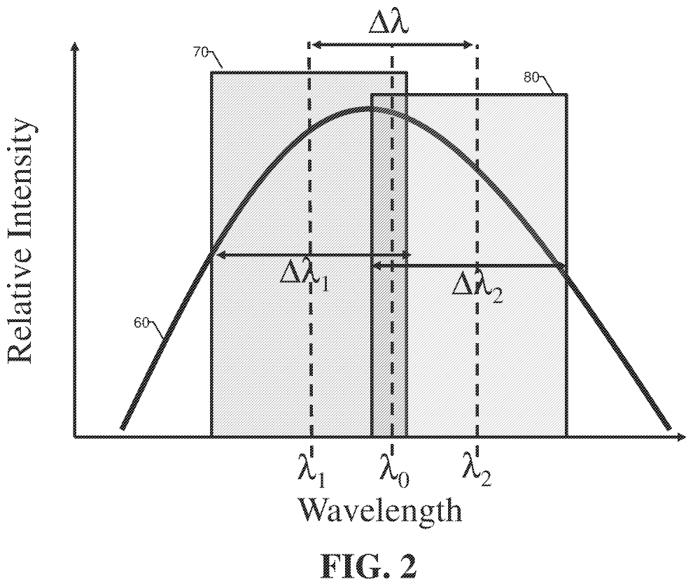

With reference to FIG. 2, the spectral output of the illumination source 1 is represented by the curve 60 having a center wavelength λ0. The response of spectral filter 15 is shown as block 70 having a center wavelength of λ1 and a bandwidth of Δλ1. The response of spectral filter 16 is shown as block 80, having a center wavelength of λ2 and a bandwidth of Δλ2. The response of spectral filter 15 and spectral filter 16 may overlap. The center wavelengths λ1 and λ2 and their separation Δλk, are used to determine the equivalent wavelength λeq, per equation 1.

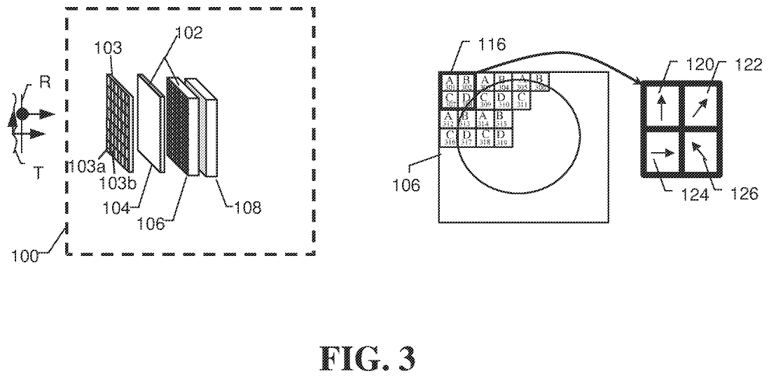

FIG. 3 illustrates one implementation of a phase sensor 100 that may be used as one of the phase sensors 20 and 21 in the polarization interferometer 50. Other implementations of phase sensors may be used if desired. As shown in FIG. 3, a pixelated polarizer mask array 106 (e.g., pixelated wire grid polarizer array) is bonded or otherwise constructed to be a part of sensor array 108, that could be for instance a CCD or CMOS type. Optionally, a quarter-waveplate 104 may be bonded to the pixelated polarizer mask array forming combined mask 102. The quarter-waveplate 104 may also be placed elsewhere in the imaging system. Additionally, as discussed above, in some implementations, the spectral filtering may occur at phase sensor level, using spectral filter array 103 that is bonded to the pixelated polarizer mask array 106. As illustrated, a spectral filter array 103 may have a repeating pattern of spectral filters 103a and 103b for wavelengths λ1 and λ2, respectively, to produce the two spectral channels at the camera level. In some implementations, both phase sensors may have different homogenous spectral filters to produce the two spectral channels at the camera level. In some implementations, the spectral filter array 103 may be a metasurface that is configured to produce the two spectral channels.

The pixelated polarizer mask array 106 is shown schematically in FIG. 3 as a repeating pattern of polarization elements 301-319. The capital letters A, B, C and D represent different transfer functions as a result of the filtering from the pixelated polarizer mask. Each unit cell 116 is comprised of a plurality of polarization orientations. FIG. 3 illustrates the unit cell 116 as including four orientations at zero degrees 120, forty-five degrees 122, ninety degrees 124 and minus forty-five degrees 126.

The signal measured at each sensor pixel is given by its transfer function, the phase-difference between the reference and test beams, and the amplitude of each beam. For example, one possible configuration is,

$$A ( x , y ) = \frac{1}{2} ( {I}_{r} + {I}_{s} + 2 \sqrt{{I}_{r} {I}_{s}} cos ( Δϕ ( x , y ) ) ) \qquad ( 2 a )$$

$$B ( x , y ) = \frac{1}{2} ( {I}_{r} + {I}_{s} + 2 \sqrt{{I}_{r} {I}_{s}} cos ( Δϕ ( x , y ) + \frac{π}{2} ) ) \qquad ( 2 b )$$

$$C ( x , y ) = \frac{1}{2} ( {I}_{r} + {I}_{s} + 2 \sqrt{{I}_{r} {I}_{s}} cos ( Δϕ ( x , y ) + π ) ) \qquad ( 2 c )$$

$$D ( x , y ) = \frac{1}{2} ( {I}_{r} + {I}_{s} + 2 \sqrt{{I}_{r} {I}_{s}} cos ( Δϕ ( x , y ) + \frac{3 π}{2} ) ) \qquad ( 2 d )$$

wherein Ir(x,y) and Is(x,y) are the irradiances of the reference and test wavefronts R and T at each x, y coordinate in the image, respectively, and Δφ(x,y) is the optical phase difference between the reference and test wavefronts which is linearly proportional to the optical path difference and further to the measured object surface as shown in Eqs. 6 and 7 below.

The resulting interferograms can be processed by a variety of algorithms that are well-known in the art for calculating phase difference and modulation index.

For example, a possible implementation for computing the phase is a simple four-bucket algorithm, e.g.,

$$Δ ϕ n ( x , y ) = {tan}^{- 1} \{ [ Cn ( x , y ) - An ( x , y ) ) ] , [ Dn ( x , y ) - B n ( x , y ) ] \} , \qquad ( 3 )$$

where the values A, B, C, and D are taken from adjacent neighboring pixels and n corresponds to either the first or second wavelength.

A phase map corresponding to the equivalent wavelength can be computed by simply subtracting phase values for like pixels between first phase-sensor 20 and second phase-sensor 21:

$$Δ ϕ e q = Δ ϕ 1 - Δ ϕ 2 \qquad ( 4 )$$

However, if there are 2π discontinuities in either calculation the resulting phase value will not necessarily compute discontinuities correctly.

With the use of polarization interferometer 50, an alternative method for calculating the phase difference at each spatial coordinate that is proportional to the equivalent wavelength and avoids the 2π discontinuities problem is given by:

$$ΔΦ eq ( x , y ) = {tan}^{- 1} [ X ( x , y ) , Y ( x , y ) ] , \qquad ( 5 )$$

$$where :$$

$$X ( x , y ) = [ {D}_{1} ( x , y ) - {B}_{1} ( x , y ) ] * [ {A}_{2} ( x , y ) - {C}_{2} ( x , y ) ] - [ {D}_{2} ( x , y ) - {B}_{2} ( x , y ) ] * [ {A}_{1} ( x , y ) - {C}_{1} ( x , y ) ] , \qquad ( 5 a )$$

$$Y ( x , y ) = [ {A}_{1} ( x , y ) - {C}_{1} ( x , y ) ] * [ {A}_{2} ( x , y ) - {C}_{2} ( x , y ) ] + [ {D}_{1} ( x , y ) - {B}_{1} ( x , y ) ] * [ {D}_{2} ( x , y ) - {B}_{2} ( x , y ) ] .$$

In equation 5a, A₁, B₁, C₁, D₁ are the pixel values from first phase-sensor 20 at wavelength λ1, and A₂, B₂, C₂, D₂ are the pixel values captured from the second phase-sensor 21 at wavelength λ2.

The three-dimensional surface shape can be determined by scaling using the equivalent wavelength according to:

$$R ( x , y ) = \frac{{λ}^{2}}{4 π Δ λ} {tan}^{- 1} ( \frac{X ( x , y )}{Y ( x , y )} ) , \qquad ( 6 )$$

where λ²=λ₁*λ₂ and Δλ=|λ₁−λ₂|. Noise in the image can be reduced using a weighted spatial average over neighboring pixels. This can be accomplished by:

$$R ( x , y ) = \frac{{λ}^{2}}{4 π Δ λ} {tan}^{- 1} ( \frac{{\sum }_{x , y ∈ δ} X ( x , y )}{{\sum }_{x , y ∈ δ} Y ( x , y )} ) , \qquad ( 7 )$$

where the sums are performed over the range of a nearest neighbors.

One implementation of the polarization interferometer is shown in FIG. 4, configured using Mireau-type interferometer optics. The system includes a broadband light source 1 that has a predefined lateral size and emits over a predefined angle. Light rays emerging from the center of the light source 1 over the full divergence angle are shown as dotted lines 2a and represent illuminating path. Light rays emerging from the edge of the source are shown as dark lines 2b and are extension to imaging path. The light is captured by collimation lens 204 and the light source 1 is imaged at the entrance pupil of the objective lens 210 by relay lens 206. Other illumination, such as critical illumination, may be used in some implementations. The polarization of the source is controlled by orientation of polarizer 3 to control the signal contrast. The light is reflected by a first non-polarizing beam splitter 208 that directs the light to polarizing interferometer optics 5 which includes a microscope objective arranged in a Mireau configuration. A polarization thin-film beam splitter 212 reflects one polarization to form a reference beam R while transmitting the remaining portion to form the test beam T. Such a polarization thin-film beams splitter 212 can be constructed, for example, by depositing an array of fine conducting wires on a glass substrate. The reference beam R is reflected from a high-quality reflective reference mirror 216 (with surface flatness <λ/10) located within the objective (possibly coated on one of the lens elements) and is subsequently reflected from the polarization thin-film beam splitter 212 a second time, re-collimated by the objective lens 210, and transmitted back through the first non-polarizing beam splitter 208. The test beam T is reflected from the test object 214, transmitted through the polarization thin-film beam splitter 212, re-collimated by the objective lens 210, and transmitted back through the first non-polarizing beam splitter 208 to form the combined orthogonally polarized reference and test beams 11. The test beam T and the reference beam R have orthogonal polarizations which may be linear or circular, e.g., if a different polarization splitting method is used. Imaging lens 220 is placed to form an image of the test surface on the first and second phase sensors 20 and 21, respectively. The splitter/filter section 12 includes a second non-polarizing beam splitter 222 that directs the beams down two paths. The first path travels through first spectral filter 15 to produce the first channel 18a. The first channel 18a optionally passes through a quarter waveplate 224 and is incident on first phase-sensor 20. The second path travels through second spectral filter 16 to produce the second channel 18a. The second channel 18b optionally passes through a second quarter waveplate 226 and is incident on second phase-sensor 21. The phase-sensor module 19 includes first and second phase-sensors 20 and 21 that are mechanically joined using a low expansion thermal material, such as Invar, and further includes a precision adjustor 22 to set the relative position of the first phase sensor 20 relative to the second phase sensor 21 so that the image is focused. The precision adjustor 22 may not be a permanent component of the final system as it could be removed after bonding the sensors in place. For example, a nano positioning stage may be used to align the second phase sensor 21 to the first phase sensor 20, e.g., to place axes, x, y, and z, to within the same plane before bonding the sensors in place. For example, the system may produce a focused image on the first phase sensor 20 over the full field of view, and a nano positioning stage of the precision adjustor 22 may be used to produce a focused image on the second phase sensor 21 over the full field of view, then to pixel match, e.g., so that the same portion of the sample is imaged in pixels of the first phase sensor 20 and the second phase sensor 21 aligned with sub-pixel accuracy. Mechanical alignment and temperature control may be used to increase stability over time, e.g., to prevent or compensate thermal drift. In some implementations, the phase sensors 20 and 21 may be aligned digitally on pixel by pixel basis to further improve mechanical alignment, correct for field aberrations differences and to provide stability over time, e.g., if phase sensors 20 and 21 drift with respect to one another over time due in a normal working environment. Digital alignment, for example may be performed by periodically measuring mismatch using a calibration surface, e.g., a flat surface with high visual contrast and includes varying unique features, such as semi-polished material scratches and divots. The mismatch may be corrected during measurements to maintain coalignment.

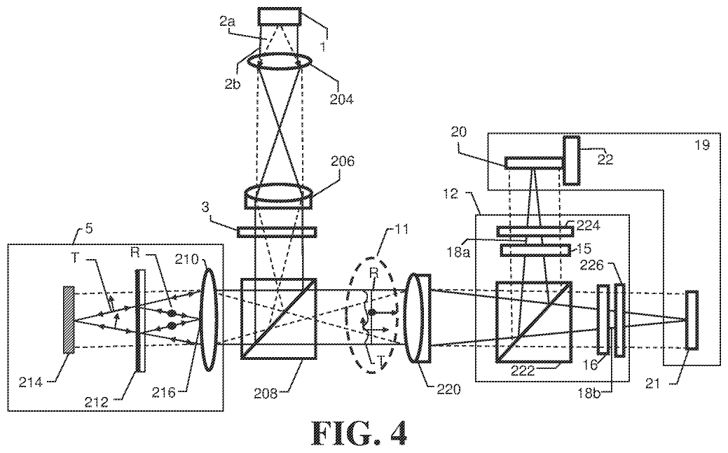

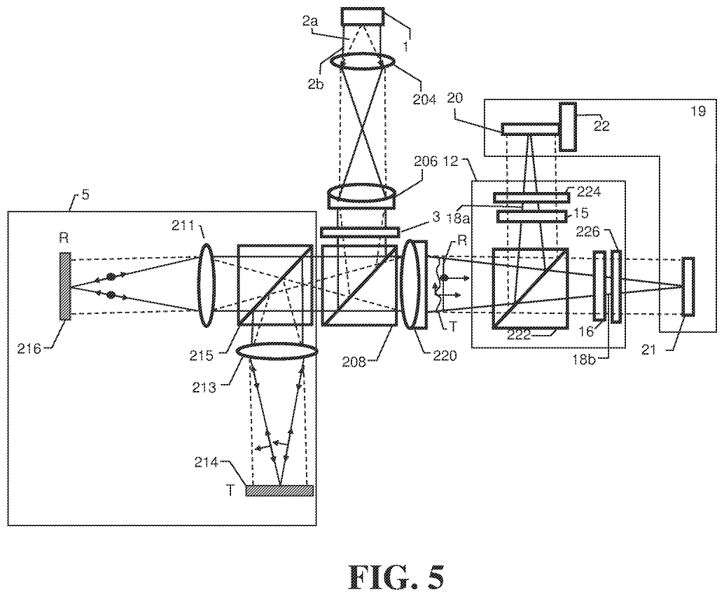

FIG. 5 illustrates a polarization interferometer according to the present disclosure configured using a modified Linnik-type interferometer. The system includes a broadband light source 1 that has a predefined lateral size and emits over a predefined angle. Light beams emerging from the center of the source over the full divergence angle are shown as dotted lines 2a and represent illuminating path. Light rays emerging from the edge of the source are shown as dark lines 2b and are extension to imaging path. The light is captured by collimation lens 204 and the broadband light source 1 is imaged at the entrance pupil of the objective lens 211 by relay lens 206. Other illumination, such as critical illumination, may be used in some implementations. The polarization of the source is controlled by orientation of polarizer 3 to control signal contrast. A first non-polarizing beam splitter 208 directs the light to polarization interferometer optics 5 that is of a so-called Linnik type and includes two microscope objective lenses 211 and 213 that are aligned to be conjugate with one another. A polarizing beam splitter 215 reflects one polarization component of the beam to form a test beam T while transmitting the remaining portion to form the reference beam R.

The reference beam R is reflected from a high-quality reflective reference mirror 216 (with surface flatness <λ/10) located at the focal plane of objective lens 211, subsequently re-collimated by the objective lens 211, and transmitted back through the polarizing beam splitter 215. The test beam T is reflected from the test object 214, re-collimated by the objective lens 213, and reflected back through the polarizing beam splitter 215 to form the combined reference and test beams 11. The test beam T and the reference beam R have orthogonal linear polarizations and are further transmitted through first non-polarizing beam splitter 208. Imaging lens 220 is placed to form an image of the test surface on the first and second phase sensors 20 and 21, respectively. The splitter/filter section 12 includes a non-polarizing beam splitter 222 that directs the beams down two paths. The first path travels through first spectral filter 15 to produce the first channel 18a. The first channel 18a optionally passes through a quarter waveplate 224 and is incident on first phase-sensor 20. The second path travels through second spectral filter 16 to produce the second channel 18a. The second channel 18b optionally passes through a second quarter waveplate 226 and is incident on second phase-sensor 21. The phase-sensor module 19 includes first and second phase-sensors 20 and 21 that are mechanically joined using a low expansion thermal material, such as Invar, and further includes a precision adjustor 22 to set the relative focus and lateral position of the first phase sensor 20 relative to the second phase sensor 21 to within sub-pixel accuracy. The precision adjustor 22 may not be a permanent component of the final system as it could be removed after bonding the sensors in place.

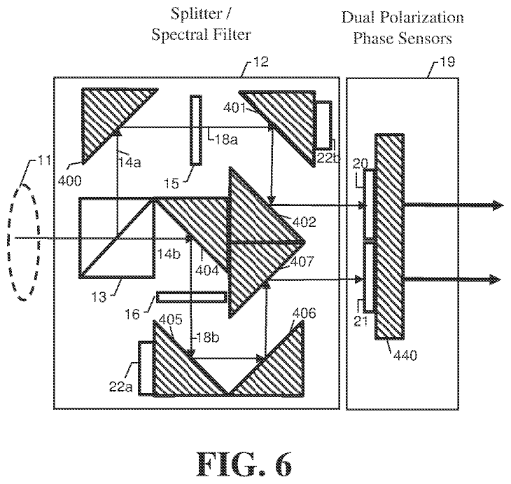

FIG. 6 shows another implementation of the splitter/spectral filter and dual polarization phase-sensor, that could be used with the polarization interferometers illustrated in FIGS. 1, 4 and 5. The combined beam 11 is incident on a non-polarizing beam splitter 13 and is partially reflected to form a first sub beam 14a and partially transmitted to form second sub-beam 14b. The first sub-beam 14a reflects from mirror 400 transmits through first spectral filter 15 to form the first spectral channel, reflects from mirrors 401 and 402 and is incident on first sensor 20. The second sub beam 14b is reflected by mirror 404 transmits through second spectral filter 16 to form the second spectral channel and subsequently reflects from mirrors 405, 406 and 407. In some implementations, the beam splitter 13 may be a dichroic beam splitter to produce the first spectral channel and the second spectral channel, thereby obviating the need for the first spectral filter 15 and the second spectral filter 16. The dual polarization phase sensor module is formed from first and second phase-sensors 20 and 21 that may be co-planar mounted on a single monolithic block 440 as part of a single camera. Mounting the phase sensors 20 and 21 on a single monolithic block 440, for example, eliminates the differential thermal drift that could occur with the sensors mounted further apart. Moreover, as part of a single camera, the first and second phase-sensors 20 and 21 are driven by the same controller so that the sensors are synchronized to capture the first channel and second channel simultaneously, and may have the same settings, shutter, gain, etc. The use of a single camera with first and second phase-sensors 20 and 21 advantageously simplifies synchronization, control, alignment, reduces space and enables a single cable output. Additionally, the first and second phase-sensors could be different regions of a single sensor array, thus further reducing any mounting or thermal drift. The splitter and spectral filter 12 further include focus adjustor 22a to ensure the focus for sub-beams 14a and 14b are identical, compensating for any chromatic difference, and angle adjustor 22b to ensure the detector regions are spatially coaligned to within a sub-pixel.

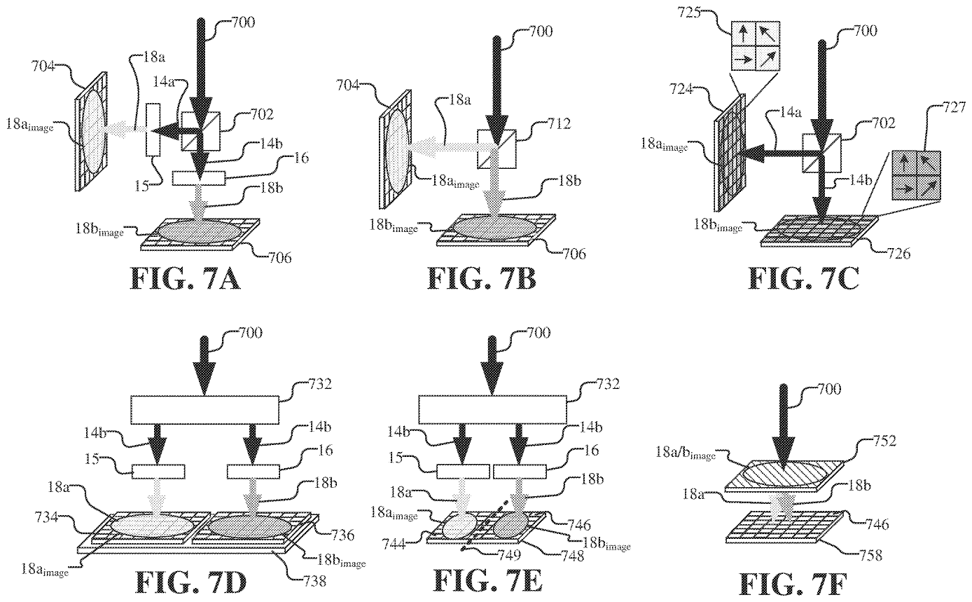

FIGS. 7A-7E illustrate various configurations of the dual spectral channels and dual-phase sensors that may be used with the polarization interferometer.

FIG. 7A illustrates the use of a beam splitter 702 that receives combined light 700 from the polarization interferometer optics 5 and splits the light into sub-beams 14a and 14b, which are filtered by spectral filters 15 and 16 to produce the two spectral channels 18a and 18b. The two spectral channels 18a and 18b are simultaneously imaged (as indicated by images 18a_{image} and 18b_{image}, respectively) by the phase sensors 704 and 706. Phase sensors 704 and 706 may include pixelated polarizer mask array bonded or otherwise constructed to be a part of sensor array, e.g., CCD or CMOS, as discussed in FIG. 3. The phase sensors 704 and 706 may be sensor arrays in separate cameras or sensor arrays in a single camera (but that are not bonded on a single substrate as illustrated in FIG. 7D below), and sensors are synchronously driven to capture the two spectral channels 18a and 18b simultaneously, and controlled to have the same settings, shutter, gain, etc. Additionally, the relative positions of the phase sensors 704 and 706 may be calibrated, e.g., mechanically or mechanically and digitally, so that images 18a_{image} and 18b_{image} are aligned laterally to within sub-pixel accuracy.

FIG. 7B is similar to FIG. 7A, but illustrates the use of a dichroic beam splitter 712 that receives combined light 700 from the polarization interferometer optics 5 and splits the light into the two spectral channels 18a and 18b that are simultaneously imaged (as indicated by images 18a_{image} and 18b_{image}, respectively) by the phase sensors 704 and 706.

FIG. 7C illustrates the use of the beam splitter 702 that receives combined light 700 from the polarization interferometer optics 5 and splits the light into sub-beams 14a and 14b. FIG. 7C is similar to FIG. 7A, but illustrates the spectral filters bonded or otherwise coupled to the phase sensors 724 and 726, as discussed in FIG. 3, to produce the two separate spectral channels. For example, as illustrated, spectral filters arrays bonded to the phase sensors 724 and 726 may have repeating pattern to produce the two spectral channels for each unit cell 725 and 727, respectively. Thus, as illustrated, each phase sensor 724 and 726 may image both spectral channels, but the phase sensors 724 and 726 are aligned so that corresponding unit cells image different spectral channels. Accordingly, the two spectral channels are simultaneously imaged (as indicated by images 18a_{image} and 18b_{image}, respectively) by the phase sensors 724 and 726. It should be understood that the patterns or combinations of polarization orientation and spectral channels may differ from what is illustrated in FIG. 7C. In some implementations, a single spectral filter, i.e., a homogenous spectral filter, may be bonded to each phase sensor 724 and 726, which is similar to the implementation illustrated in FIG. 7A, but with the spectral filter bonded to the phase sensors.

FIG. 7D illustrates the use of a beam splitter 732 that receives combined light 700 from the polarization interferometer optics 5 and splits the light into sub-beams 14a and 14b, which are filtered by spectral filters 15 and 16 to produce the two spectral channels 18a and 18b, e.g., such as illustrated in FIG. 6. In some implementations, a dichroic beam splitter may be used to produce the two spectral channels 18a and 18b, thereby obviating the need for spectral filters 15 and 16. The two spectral channels 18a and 18b are simultaneously imaged (as indicated by images 18a_{image} and 18b_{image}, respectively) by the phase sensors 734 and 736. Each of the phase sensors 734 and 736 may be a pixelated polarizer mask array bonded or otherwise constructed to be a part of sensor array, e.g., CCD or CMOS, as discussed in FIG. 3 that are mounted together on the same block 738 in a single camera. Phase sensors 734 and 736 may be driven by the same controller so that the phase sensors are synchronized to capture the two spectral channels 18a and 18b simultaneously and have the same settings, shutter, gain, etc. Additionally, the relative positions of the phase sensors 734 and 736 are fixed and may be calibrated, e.g., mechanically or mechanically and digitally, so that images 18a_{image} and 18b_{image} are aligned laterally to within sub-pixel accuracy.

FIG. 7E illustrates the use of the beam splitter 732 that receives combined light 700 from the polarization interferometer optics 5 and splits the light into sub-beams 14a and 14b, which are filtered by spectral filters 15 and 16 to produce the two spectral channels 18a and 18b, e.g., such as illustrated in FIG. 6. In some implementations, a dichroic beam splitter may be used to produce the two spectral channels 18a and 18b, thereby obviating the need for spectral filters 15 and 16. FIG. 7E is similar to FIG. 7D, but illustrates that the two spectral channels 18a and 18b are simultaneously imaged (as indicated by images 18a_{image} and 18b_{image}, respectively) by the phase sensors 744 and 746, which are two separate regions of a single phase sensor array 748. The phase sensor array 748 may be a pixelated polarizer mask array bonded or otherwise constructed to be a part of the sensor array, e.g., CCD or CMOS, as discussed in FIG. 3, that is divided into two regions, as indicated by dotted line 749 to produce the two phase sensors 744 and 746. As the phase sensors 744 and 746 are different regions of a single phase sensor array 748, the phase sensors 744 and 746 are synchronized to capture the two spectral channels 18a and 18b simultaneously and have the same settings, shutter, gain, etc. Additionally, the relative positions of the phase sensors 734 and 736 are fixed and may be calibrated, e.g., mechanically or mechanically and digitally, so that images 18a_{image} and 18b_{image} are aligned laterally to within sub-pixel accuracy.

FIG. 7F illustrates the use of a metasurface 752 that receives combined light 700 from the polarization interferometer optics 5 and is configured to split the light into the two spectral channels 18a and 18b. The metasurface 752 may be bonded to or otherwise coupled to the phase sensor array 758 (e.g., as illustrated in FIG. 3), but is shown separated in FIG. 7F for illustrative purposes. The metasurface 752 may be configured so that each point (e.g., each pixel on the metasurface) is split into the two spectral channels 18a and 18b, which are directed to be incident on two separate unit cells of the phase sensor array 758. Thus, two unit cells of the phase sensor array 758 capture the two spectral channels 18a and 18b from the same location in the image 18a/b_{image}. Accordingly, the metasurface 752 and phase sensor array 758 serve as two interlaced phase sensors that are configured to capture the two separate spectral channels simultaneously. Other configurations of the metasurface 752 and phase sensor array 758 are possible. Different sensors with coaligned color images exist and the pixelated polarization mask of phase sensor may be combined with such sensors which are made of vertically stacked color photodiodes, each having different spectral sensitivity. Spectral splitting happens in vertical stack of photodiodes, and two spectral channels are captured by two coaligned vertically stacked pixel array.

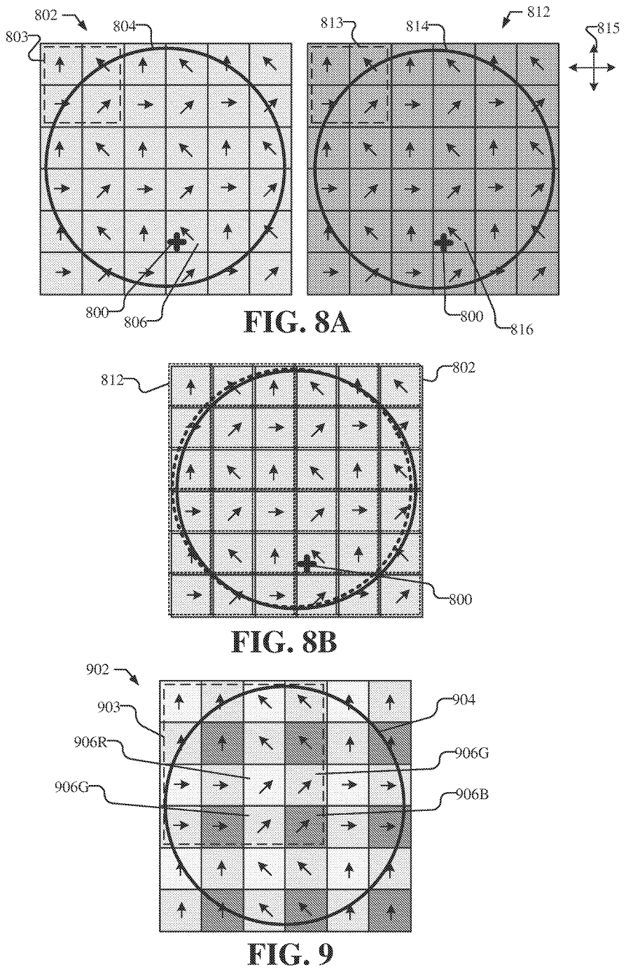

FIGS. 8A and 8B, by way of example, illustrate sub-pixel alignment of corresponding pixels in pixelated polarization phase sensors. FIG. 8A illustrates a first pixelated polarization phase sensor 802 that captures a first image 804 of a test object in the first spectral channel and a second pixelated polarization phase sensor 812 that captures a second image 814 of the test object in the second spectral channel. It should be understood that the first image 804 and the second image 814 are identical images of the test object, e.g., produced by splitting the combined beam 11 (as shown in FIG. 1). The first pixelated polarization phase sensor 802 and the second pixelated polarization phase sensor 812 may be aligned, e.g., laterally, rotationally, skew, magnification, field aberrations, etc. (illustrated by arrows 815), with sub-pixel accuracy so that a same location on the test object, illustrated by cross 800, is imaged in corresponding pixels 806 and 816 in the first pixelated polarization phase sensor 802 and the second pixelated polarization phase sensor 812. FIG. 8B illustrates the sub-pixel alignment of the first pixelated polarization phase sensor 802 and the second pixelated polarization phase sensor 812 by showing the second pixelated polarization phase sensor 812 (with dotted lines) overlapping the first pixelated polarization phase sensor 802. As can be seen in FIG. 8B, the same location on the test object, illustrated by cross 800, is imaged in corresponding pixels of the first pixelated polarization phase sensor 802 and the second pixelated polarization phase sensor 812.

FIG. 9 illustrates a pixelated polarization phase sensor 902 that is overlaid with an RGB Bayer filter (illustrated with different shadings) in order to collect three spectral (RGB) channels. FIG. 9 further illustrates an image 904 of the test object that is collected by the pixelated polarization phase sensor 902 with the three spectral channels. As can be seen, due to the multiple spectral channels, a unit cell 903 of the pixelated polarization phase sensor 902 is four pixels in height and width. While the pixelated polarization phase sensor 902 may capture the image 904 in all three spectral channels with a single shot, corresponding pixels for each spectral channel will image a different location of the test object. For example, corresponding pixels 906R, 906G, and 906B for the red, green, and blue spectral channels, are adjacent pixels (i.e., they are a full pixel apart) in the array and accordingly will image a different location on the test object. A pixelated polarization phase sensor 902 may be suitable for measuring relatively smooth surfaces, e.g., surfaces where there is little or no variation in local height between pixels, but it is unsuitable for measurement of surface roughness as contemplated herein, e.g., surface roughness that has local height variation larger than individual λ1 or λ2, λ/8 or λ/4 (or greater) between measured pixels. Additionally, the pixelated polarization phase sensor 902 without sub-pixel alignment is larger to receive the spectral channels, i.e., the unit cell 903 is significantly larger than unit cells 803 and 813 of respective pixelated polarization phase sensor 802 and 812, and accordingly, the high frequency component of roughness that can be resolved by pixelated polarization phase sensor 902 is greatly reduced, e.g., reduced by half.

The alignment of the phase sensors may be performed mechanically as discussed above. In some implementations, it may be desirable to additionally or alternatively align the phase sensors digitally to further improve the alignment and correct for possible field aberrations, residual relative camera/image tilt effect, temperature influences etc. Digital alignment of the phase sensors may be performed through a calibration process. By applying the digital calibration process to one image captured by one phase sensor or partially to both images captures by both phase sensors, each of the newly generated images will be aligned with sub-pixel accuracy to within a fraction of a pixel's width, e.g., less than 20%, 10%, or 5% of the pixel width.

Suitable software applications may be utilized by the computer 32 (see FIG. 1) for data acquisition and processing for each of the foregoing implementations of measuring systems according to the present disclosure. The software application would preferably cause the computer 34 to acquire, process, analyze, and display data on the display 36. Data acquisition may be accomplished, for example, by recording a single interferogram from each phase-sensor 20 and 21. Wrapped phase map of the equivalent wavelength are then calculated using algorithms such as Equation 5. The result is unwrapped to yield a map of the phase difference between the reference and object wavefronts at the equivalent wavelength. As is well understood in the art, “unwrapping” refers to the procedure used to remove the modulo 2π ambiguity that is characteristic of interferometric data.

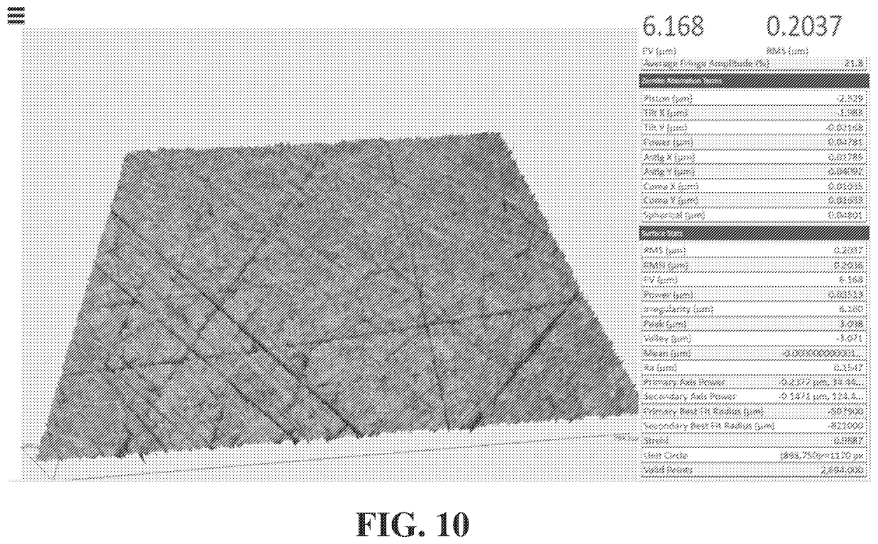

FIG. 10 illustrates the performance of a measurement system according to the present disclosure. In particular, the image shown in FIG. 10 was obtained with a Linnik type interferometric system, similar to that shown in FIG. 5, with a light source that produces a center wavelength λ0 of 567 nm and a full width of 100 nm, and a first spectral filter with a center wavelength λ1 at 535 nm and a second spectral filter with a center wavelength of λ2 at 560 nm. A high-quality flat mirror was used as the reference mirror 216 and a honed cylinder was used as the test object 214. The measurement shows structures with vertical features as tall as 6 microns, which is much greater than the wavelength of light (567 nm) and demonstrates the ability to accomplish single shot surface roughness measurements of non-optically smooth surfaces with high vertical resolution, sub-micron lateral resolution, and a large field of view, e.g., 754 μm.

The above description is intended to be illustrative, and not restrictive. For example, the above-described examples (or one or more aspects thereof) may be used in combination with each other. Other implementations can be used, such as by one of ordinary skill in the art upon reviewing the above description. Also, various features may be grouped together and less than all features of a particular disclosed implementation may be used. For example, the present disclosure has been described throughout using primarily linearly polarized test and reference beams directed to the pixilated phase-mask, but circularly polarized beams would work as well in all of the disclosed systems so long as orthogonally polarized. Thus, the following aspects are hereby incorporated into the above description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A polarization interferometer for determining a surface roughness of a test object, comprising:
an illumination source that produces light having multiple wavelengths;
polarization interferometer optics that split the light into two orthogonally polarized beams comprising a reference beam and a test beam, wherein the test beam is incident on and is returned from the test object, the polarization interferometer optics recombine the test beam and the reference beam into a combined beam;
at least one spectral filter that spectrally filters the combined beam into two spectral channels, a first spectral channel having a first center wavelength and a second spectral channel having a second center wavelength, wherein the first center wavelength and the second center wavelength are different;
two pixelated polarization phase sensors configured to capture images of the two spectral channels at a same time, wherein the two pixelated polarization phase sensors are configured to produce a phase map of a surface of the test object corresponding to an equivalent wavelength for the first center wavelength and the second center wavelength; and
a computer configured to determine the surface roughness of the test object based on the phase map, wherein the surface roughness of neighboring height variations are greater than 20 nanometers (nm) root mean square (RMS).

2. The polarization interferometer of claim 1, wherein the illumination source comprises a polarizer that controls a polarization state and orientation of polarization of the light received by the polarization interferometer optics.

3. The polarization interferometer of claim 1, wherein the illumination source comprises a light source that produces polarized light.

4. The polarization interferometer of claim 1, wherein the surface roughness of the test object is between 50 nm and 10 micrometers.

5. The polarization interferometer of claim 1, wherein the illumination source comprises one of a single broadband light source, a single light source that produces multiple wavelengths, or multiple light sources.

6. The polarization interferometer of claim 1, further comprising:
a beam splitter that splits the combined beam into a first sub-beam and a second sub-beam;
wherein the at least one spectral filter comprises:
a first spectral filter that receives the first sub-beam and filters the first sub-beam to produce the first spectral channel with the first center wavelength; and
a second spectral filter that receives the second sub-beam and filters the second sub-beam to produce the second spectral channel having the second center wavelength.

7. The polarization interferometer of claim 1, wherein the at least one spectral filter comprises a dichroic beam splitter that splits the combined beam into the first spectral channel with the first center wavelength and the second spectral channel with the second center wavelength.

8. The polarization interferometer of claim 1, wherein the at least one spectral filter comprises pixelated wavelength filters on the two pixelated polarization phase sensors.

9. The polarization interferometer of claim 1, wherein the first center wavelength and the second center wavelength differ by at least 10 nm.

10. The polarization interferometer of claim 1, wherein the surface roughness has neighboring height variations larger than ⅛ of an individual measurement wavelength over a single pixel width but less than ¼ of equivalent wavelength.

11. The polarization interferometer of claim 1, wherein the two pixelated polarization phase sensors are one of separate sensor arrays in different cameras, separate sensor arrays in a single camera, and are different regions of a single sensor array.

12. The polarization interferometer of claim 1, further comprising a computer configured to digitally align the two pixelated polarization phase sensors based on calibration data.

13. A method of polarization interferometry for determining a surface roughness of a test object, comprising:
producing light having multiple wavelengths with an illumination source;
splitting the light into two orthogonally polarized beams comprising a reference beam and a test beam with polarization interferometer optics, wherein the test beam is incident on and is returned from the test object, and recombining the test beam and the reference beam into a combined beam with the polarization interferometer optics;
spectrally filtering the combined beam into two spectral channels with at least one spectral filter, a first spectral channel having a first center wavelength and a second spectral channel having a second center wavelength, wherein the first center wavelength and the second center wavelength are different;
capturing images of the two spectral channels at a same time with two pixelated polarization phase sensors;
producing a phase map for a surface of the test object corresponding to an equivalent wavelength for the first center wavelength and the second center wavelength; and
determining the surface roughness of the test object based on the phase map, wherein the surface roughness of neighboring height variations are greater than 20 nanometers (nm) root mean square (RMS).

14. The method of claim 13, further comprising controlling a polarization state and orientation of polarization of the light received by the polarization interferometer optics with a polarizer.

15. The method of claim 13, further comprising polarizing the light with a light source in the illumination source.

16. The method of claim 13, wherein the surface roughness of the test object is between 50 nm and 10 micrometers.

17. The method of claim 13, further comprising:
splitting the combined beam into a first sub-beam and a second sub-beam with a beam splitter;
wherein spectrally filtering the combined beam into the two spectral channels with the at least one spectral filter comprises:
filtering the first sub-beam with a first spectral filter that receives the first sub-beam to produce the first spectral channel with the first center wavelength; and
filtering the second sub-beam with a second spectral filter that receives the second sub-beam to produce the second spectral channel having the second center wavelength.

18. The method of claim 13, wherein spectrally filtering the combined beam into the two spectral channels with the at least one spectral filter comprises splitting the combined beam into the first spectral channel with the first center wavelength and the second spectral channel with the second center wavelength with a dichroic beam splitter.

19. The method of claim 13, wherein the at least one spectral filter comprises pixelated wavelength filters on the two pixelated polarization phase sensors.

20. The method of claim 13, wherein the first center wavelength and the second center wavelength differ by at least 10 nm.

21. The method of claim 13, wherein the surface roughness has neighboring height variations larger than ⅛ of a measurement wavelength over a single pixel width.

22. The method of claim 13, wherein the two pixelated polarization phase sensors are one of separate sensor arrays in different cameras, separate sensor arrays in a single camera, and are different regions of a single sensor array.
